(19) United States
(12) Patent Application Publication
(10) Pub. No.: US 2025/0352960 A1
(43) Pub. Date: Nov. 20, 2025

(54) STIRRING ASSEMBLY AND MILK FROTHER

(71) Applicant: Shenzhen Chuangpu Network Technology Co., Ltd., Shenzhen (CN)

(72) Inventors: Liupu Xiang, Ezhou (CN); Jifu Xie, Ezhou (CN)

(21) Appl. No.: 18/747,801

(22) Filed: Jun. 19, 2024

(30) Foreign Application Priority Data
May 15, 2024 (CN) 202410626882.6

(51) Int. Cl. B01F 27/2123; A47J 43/046; A47J 43/07; A47J 43/12; B01F 23/233; B01F 27/13; B01F 27/808; B01F 27/81; B01F 101/07

(52) U.S. Cl. CPC B01F 27/2123; A47J 43/046; A47J 43/0722; A47J 43/126; A47J 43/127; B01F 23/23361; B01F 27/13; B01F 27/808; B01F 27/811; B01F 2101/07

(57) ABSTRACT

The present invention is in the field of stirring, and particularly relates to a stirring assembly including a rotary shaft and a stirring member. The stirring member is fixedly provided on the rotary shaft. The rotary shaft is provided with a first passage therein. The first passage is formed with an air inlet through one end of the rotary shaft. The stirring member is provided with a second passage therein. The second passage is formed with an air outlet through the stirring member. The second passage is connected with the first passage. In the present invention, when the rotary shaft is rotating, the external air is drawn in from the air inlet and discharged from the air outlet to make the liquid to be mixed by the stirring member with the air discharged from the air outlet.

### CROSS REFERENCE TO RELATED APPLICATIONS

The present application claims the benefit of Chinese Patent Application No. 202410626882.6 filed on May 15, 2024, the contents of which are incorporated herein by reference in their entirety.

### TECHNICAL FIELD

The present invention is in the field of stirring, and more particularly relates to a stirring assembly and a milk frother.

### BACKGROUND ART

A stirring device is a structure for stirring the liquid by rotating to achieve uniform stirring of the liquid or to achieve more sufficient contact of the liquid with air to mix more air.

A stirrer of a milk frother as disclosed in the prior patent (application number CN202321183298.5), including a positioning column provided at the bottom wall of a container of the milk frother; a base rotatably connected to the positioning column; several magnets are provided inside; an inner cavity is provided in the middle and configured to accommodate the positioning column; the base has an elastic presser provided in the inner cavity; one of the elastic presser and the positioning column is provided with a protruding portion, and the other of the elastic presser and the positioning column is provided with a groove accommodating the protruding portion; and the protruding portion cooperates with the groove to prevent falling off; and a spring ring sheathed outside the base and configured to stir the material in the container. The stirrer is designed to mix air into the milk through stirring to form milk froth, but when the stirrer is stirring, the amount of air mixed into the milk is small, and the effect of the formation of milk froth is relatively poor, which does not better meet the needs of the user.

### SUMMARY OF THE INVENTION

In order to solve the above problems, it is an objective of the present invention to provide a stirring assembly that allows more air to be mixed into a liquid to achieve a better stirring effect when stirring.

It is another objective of the present invention to provide a milk frother that allows more liquid to be mixed into the milk during stirring, resulting in better milk froth formation.

In order to achieve the above objectives, the technical solution of the present invention is as follows.

A stirring assembly, including a rotary shaft, and a stirring member, wherein the stirring member is fixedly provided on the rotary shaft; the rotary shaft is provided with a first passage therein; the first passage is formed with an air inlet through one end of the rotary shaft; the stirring member is provided with a second passage therein; the second passage is formed with an air outlet through the stirring member; the second passage is connected with the first passage; and the other end of the rotary shaft is provided with a connection position connected to an external rotary drive structure.

In the stirring assembly, the external rotary drive structure drives the rotary shaft to rotate at a high speed through the connection position, and carries out high-speed rotary stirring on the liquid through the stirring member; when the rotary shaft is rotating, the air pressure at the air inlet is higher than the air pressure at the air outlet, which draws in the external air from the air inlet and discharges it from the air outlet through the first passage and the second passage to make the liquid to be mixed by the stirring member with the air discharged from the air outlet to achieve a better stirring effect.

Further, the air outlet is located at one end of the stirring member, and the other end of the stirring member is fixed to the rotary shaft. The air discharged from one end of the stirring member can be better mixed with the liquid rotated and stirred by the stirring member at a high speed.

Further, the stirring member is inclinedly provided on the outer side of the rotary shaft, and the angle formed between the stirring member and the other end of the rotary shaft is an acute angle. The inclined setting that the angle between the stirring frame and the other end of the rotary shaft is an acute angle makes it possible to better drive the liquid when the stirring member rotates.

Further, the connection position includes a connection groove provided at the other end of the rotary shaft.

Further, the stirring member is fitted with a stirring spring. The stirring spring can be provided in such a way that the stirring member can make the stirring effect better when stirring the liquid and make the mixing effect of the liquid and the air better.

Further, the stirring member is provided with a snap-in projection at one end, and the stirring spring is detachably fitted to one end of the stirring member through the snap-in projection.

Further, the quantity of the stirring members is plurality and a plurality of stirring members are provided around the rotary shaft.

Further, the quantity of the stirring members is twice the quantity of stirring springs, and both ends of the stirring springs are fitted to one end of two adjacent stirring members respectively.

Further, the stirring member is four or more, and the stirring spring is two or more.

Further, the rotary shaft includes a first rotary shaft and a second rotary shaft; the stirring member includes a first stirring member and a second stirring member; the first passage is provided in the first rotary shaft and passes through two ends of the first rotary shaft; the air inlet is located at one end of the first rotary shaft; the first stirring member is fixedly provided at the other end of the first rotary shaft; and the first stirring member is provided with a first air groove; and

the connection position is provided at one end of the second rotary shaft; the second stirring member is provided with a second air groove; the second stirring member is detachably clamped to the first stirring member; the first air groove and the second air groove are enclosed to form the second passage; and the first rotary shaft and the second rotary shaft are coaxial. The structure design of the rotary shaft and the stirring member makes the production and installation of the stirring assembly more convenient.

A milk frother includes a main body, a rotary drive assembly, and a stirring assembly, wherein the main body is provided with a stirring tank; the stirring assembly is provided within the stirring tank; the rotary drive assembly is fixedly provided within the main body; and the rotary drive assembly extends into the stirring tank and is drivingly connected to the connection position of the stirring assembly. In the milk frother, after the milk is contained in the stirring tank, the rotary drive assembly drives the rotary shaft to rotate at a high speed, and the stirring member carries out high-speed rotary stirring on the liquid. When the rotary shaft is rotating, the air pressure at the air inlet is higher than the air pressure at the air outlet, which draws in the external air from the air inlet and discharges it from the air outlet through the first passage and the second passage to make the milk to be mixed by the stirring member with the air discharged from the air outlet to achieve a better stirring effect and form a better milk froth.

An advantageous effect of the present invention is that in the stirring assembly, the external rotary drive structure drives the rotary shaft to rotate at a high speed through the connection position, and carries out high-speed rotary stirring on the liquid through the stirring member; and when the rotary shaft is rotating, the air pressure at the air inlet is higher than the air pressure at the air outlet, which draws in the external air from the air inlet and discharges it from the air outlet through the first passage and the second passage to make the liquid to be mixed by the stirring member with the air discharged from the air outlet to achieve a better stirring effect.

### BRIEF DESCRIPTION OF THE DRAWINGS

FIG. 1 is a structural schematic diagram of a stirring assembly.

FIG. 2 is a structural schematic diagram of a stirring assembly with a stirring spring being hidden.

FIG. 3 is an exploded view of a stirring assembly with a stirring spring being hidden.

FIG. 4 is a structural schematic diagram of a milk frother.

FIG. 5 is an exploded view of a milk frother.

1, stirring assembly; 11, rotary shaft; 111, first passage; 112, air inlet; 113, connection position; 1131, connection groove; 114, first rotary shaft; 115, second rotary shaft; 12, stirring member; 121, second passage; 122, air outlet; 123, snap-in projection; 124, first stirring member; 1241, first air groove; 125, second stirring member; 1251, second air groove; 13, stirring spring;
2, main body; 21, stirring tank; and
3, rotary drive assembly.

### DETAILED DESCRIPTION OF THE INVENTION

In order that the objects, aspects, and advantages of the present invention will become more apparent, the present invention will be further described in detail with reference to the accompanying drawings and embodiments. It should be understood that the specific embodiments described herein are illustrative only and are not limiting.

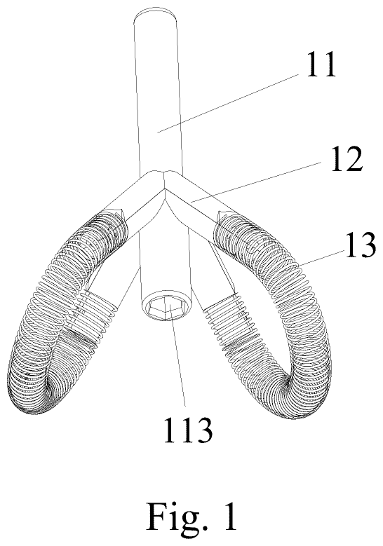

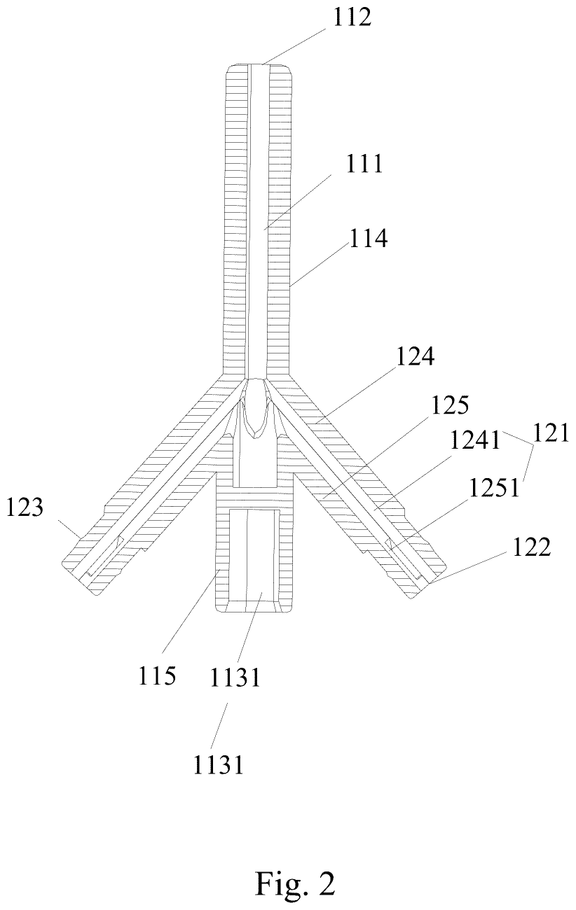

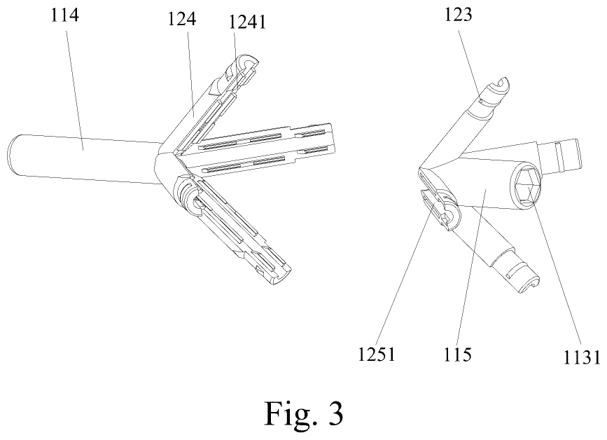

With reference to FIGS. 1-3, the present embodiment provides a stirring assembly 1 including a rotary shaft 11 and a stirring member 12. The stirring member 12 is fixedly provided on the outer side of the rotary shaft 11. The rotary shaft 11 is provided with a first passage 111 therein. The first passage 111 is formed with an air inlet 112 through one end of the rotary shaft 11. The stirring member 12 is provided with a second passage 121 therein. The second passage 121 is formed with an air outlet 122 through the stirring member 12. The second passage 121 is connected with the first passage 111. The other end of the rotary shaft 11 is provided with a connection position 113 connected to an external rotary drive structure.

In the present embodiment, the air outlet 122 is located at one end of the stirring member 12, and the other end of the stirring member 12 is fixed to the rotary shaft 11 such that the second passage 121 is communicated with the first passage 111 through the other end of the stirring member 12.

In the present embodiment, the stirring member 12 is obliquely provided outside the rotary shaft 11, and an included angle formed between the stirring member 12 and the other end of the rotary shaft 11 is an acute angle.

In the present embodiment, the connection position 113 includes a connection groove 1131 provided at the other end of the rotary shaft 11. The external rotary drive structure is detachably inserted into the connection groove 1131 to be installed at the connection position 113.

In this embodiment, the stirring member 12 is fitted with a stirring spring 13.

In the present embodiment, the stirring member 12 is provided with a snap-in projection 123 at one end, and the stirring spring 13 is detachably fitted to one end of the stirring member 12 through the snap-in projection 123.

In the present embodiment, the quantity of the stirring member 12 is plurality and a plurality of stirring members 12 are provided around the outer side of the rotary shaft 11.

In the present embodiment, the quantity of the stirring members 12 is twice the quantity of stirring springs 13, and both ends of stirring springs 13 are fitted to one end of two adjacent stirring members 12 respectively.

In the present embodiment, the stirring members 12 are four, and the four stirring members 12 uniformly surround the outside of the rotary shaft 11. The stirring springs 13 are two and the two stirring springs 13 are symmetrically provided.

In the present embodiment, the rotary shaft 11 includes a first rotary shaft 114 and a second rotary shaft 115. The stirring member 12 includes a first stirring member 124 and a second stirring member 125. The first passage 111 is provided in the first rotary shaft 114 and passes through two ends of the first rotary shaft 114. The air inlet 112 is located at one end of the first rotary shaft 114. The first stirring member 124 is fixedly provided at the other end of the first rotary shaft 114. The first stirring member 124 is provided with a first air groove 1241.

The connection position 113 is provided at one end of the second rotary shaft 115. The second stirring member 125 is provided with a second air groove 1251. The second stirring member 125 is detachably clamped to the first stirring member 124. The first air groove 1241 and the second air groove 1251 are enclosed to form the second passage 121. The first rotary shaft 114 and the second rotary shaft 115 are coaxial.

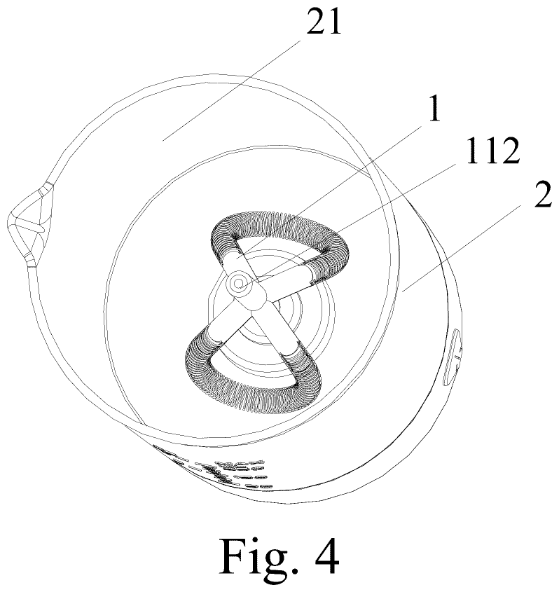

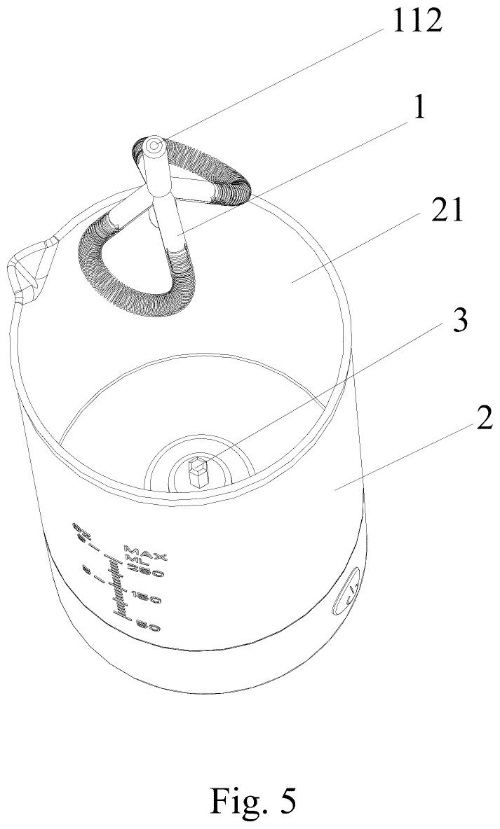

With reference to FIGS. 1-5, the present embodiment provides a milk frother. The milk frother includes a main body 2, a rotary drive assembly 3, and a stirring assembly 1. The main body 2 is provided with a stirring tank 21. The stirring assembly 1 is provided within the stirring tank 21. The rotary drive assembly 3 is fixedly provided within the main body 2. The rotary drive assembly 3 extends into the stirring tank 21 and is drivingly connected to a connection position 113 of the stirring assembly 1. The stirring assembly 1 is driven to rotate within the stirring tank 21 by the rotary drive assembly 3 to achieve stirring and frothing of the milk within the stirring tank 21.

Specifically, the rotary drive assembly 3 includes a motor, a control main board, a control key, a battery, and other structures. The motor, the control main board, and the battery are all provided in the main body 2. The control key is provided outside the main body 2. The output shaft of the motor extends into the stirring tank 21 to connect with the connection position 113 of the rotary shaft 11. The motor, the control key, and the battery are all electrically connected to the control main board. The above-mentioned motor is a structure for driving the rotation of the stirring assembly 1. The control main board is a PCB board integrated with electronic components for controlling the work of the motor. The circuits thereon are prior art. The battery is a structure that provides power to the motor and the control main board, and the control key is a key structure that controls the motor's operating status by the control main board.

The above is only a preferred implementation of the present invention and does not limit it. Any modifications, equivalent substitutions, improvements, etc. made within the spirit and principles of the present invention should be included in the scope of protection of the present invention.

1. A stirring assembly, comprising a rotary shaft and a stirring member, wherein the stirring member is fixedly provided on the rotary shaft; the rotary shaft is provided with a first passage therein; the first passage is formed with an air inlet through one end of the rotary shaft; the stirring member is provided with a second passage therein; the second passage is formed with an air outlet through the stirring member; the second passage is connected with the first passage; and the other end of the rotary shaft is provided with a connection position connected to an external rotary drive structure.

2. The stirring assembly according to claim 1, wherein the air outlet is located at one end of the stirring member, and the other end of the stirring member is fixed to the rotary shaft.

3. The stirring assembly according to claim 1, wherein the stirring member is inclinedly provided on the outer side of the rotary shaft, and the angle formed between the stirring member and the other end of the rotary shaft is an acute angle.

4. The stirring assembly according to claim 1, wherein the connection position comprises a connection groove provided at the other end of the rotary shaft.

5. The stirring assembly according to claim 1, wherein the stirring member is fitted with a stirring spring.

6. The stirring assembly according to claim 5, wherein the stirring member is provided with a snap-in projection at one end and the stirring spring is detachably fitted to one end of the stirring member through the snap-in projection.

7. The stirring assembly according to claim 5, wherein the quantity of the stirring members is plurality and a plurality of stirring members are provided around the rotary shaft; the quantity of the stirring members is twice the quantity of stirring springs, and both ends of the stirring springs are fitted to one end of two adjacent stirring members respectively.

8. The stirring assembly according to claim 7, wherein the stirring members are four or more and the stirring springs are two or more.

9. The stirring assembly according to claim 1, wherein the rotary shaft comprises a first rotary shaft and a second rotary shaft; the stirring member comprises a first stirring member and a second stirring member; the first passage is provided in the first rotary shaft and passes through two ends of the first rotary shaft; the air inlet is located at one end of the first rotary shaft; the first stirring member is fixedly provided at the other end of the first rotary shaft; and the first stirring member is provided with a first air groove; and
the connection position is provided at one end of the second rotary shaft; the second stirring member is provided with a second air groove; the second stirring member is detachably clamped to the first stirring member; the first air groove and the second air groove are enclosed to form the second passage; and the first rotary shaft and the second rotary shaft are coaxial.

10. The stirring assembly according to claim 8, wherein the rotary shaft comprises a first rotary shaft and a second rotary shaft; the stirring member comprises a first stirring member and a second stirring member; the first passage is provided in the first rotary shaft and passes through two ends of the first rotary shaft; the air inlet is located at one end of the first rotary shaft; the first stirring member is fixedly provided at the other end of the first rotary shaft; and the first stirring member is provided with a first air groove; and
the connection position is provided at one end of the second rotary shaft; the second stirring member is provided with a second air groove; the second stirring member is detachably clamped to the first stirring member; the first air groove and the second air groove are enclosed to form the second passage; and the first rotary shaft and the second rotary shaft are coaxial.

11. A milk frother, comprising a main body, a rotary drive assembly, and the stirring assembly according to claim 1, wherein the main body is provided with a stirring tank; the stirring assembly is provided within the stirring tank; the rotary drive assembly is fixedly provided within the main body; and the rotary drive assembly extends into the stirring tank and is drivingly connected to the connection position of the stirring assembly.

12. A milk frother, comprising a main body, a rotary drive assembly, and the stirring assembly according to claim 2, wherein the main body is provided with a stirring tank; the stirring assembly is provided within the stirring tank; the rotary drive assembly is fixedly provided within the main body; and the rotary drive assembly extends into the stirring tank and is drivingly connected to the connection position of the stirring assembly.

13. A milk frother, comprising a main body, a rotary drive assembly, and the stirring assembly according to claim 3, wherein the main body is provided with a stirring tank; the stirring assembly is provided within the stirring tank; the rotary drive assembly is fixedly provided within the main body; and the rotary drive assembly extends into the stirring tank and is drivingly connected to the connection position of the stirring assembly.

14. A milk frother, comprising a main body, a rotary drive assembly, and the stirring assembly according to claim 4, wherein the main body is provided with a stirring tank; the stirring assembly is provided within the stirring tank; the rotary drive assembly is fixedly provided within the main body; and the rotary drive assembly extends into the stirring tank and is drivingly connected to the connection position of the stirring assembly.

15. A milk frother, comprising a main body, a rotary drive assembly, and the stirring assembly according to claim 5, wherein the main body is provided with a stirring tank; the stirring assembly is provided within the stirring tank; the rotary drive assembly is fixedly provided within the main body; and the rotary drive assembly extends into the stirring tank and is drivingly connected to the connection position of the stirring assembly.

16. A milk frother, comprising a main body, a rotary drive assembly, and the stirring assembly according to claim 6, wherein the main body is provided with a stirring tank; the stirring assembly is provided within the stirring tank; the rotary drive assembly is fixedly provided within the main body; and the rotary drive assembly extends into the stirring tank and is drivingly connected to the connection position of the stirring assembly.

17. A milk frother, comprising a main body, a rotary drive assembly, and the stirring assembly according to claim 7, wherein the main body is provided with a stirring tank; the stirring assembly is provided within the stirring tank; the rotary drive assembly is fixedly provided within the main body; and the rotary drive assembly extends into the stirring tank and is drivingly connected to the connection position of the stirring assembly.

18. A milk frother, comprising a main body, a rotary drive assembly, and the stirring assembly according to claim 8, wherein the main body is provided with a stirring tank; the stirring assembly is provided within the stirring tank; the rotary drive assembly is fixedly provided within the main body; and the rotary drive assembly extends into the stirring tank and is drivingly connected to the connection position of the stirring assembly.

19. A milk frother, comprising a main body, a rotary drive assembly, and the stirring assembly according to claim 9, wherein the main body is provided with a stirring tank; the stirring assembly is provided within the stirring tank; the rotary drive assembly is fixedly provided within the main body; and the rotary drive assembly extends into the stirring tank and is drivingly connected to the connection position of the stirring assembly.

20. A milk frother, comprising a main body, a rotary drive assembly, and the stirring assembly according to claim 10, wherein the main body is provided with a stirring tank; the stirring assembly is provided within the stirring tank; the rotary drive assembly is fixedly provided within the main body; and the rotary drive assembly extends into the stirring tank and is drivingly connected to the connection position of the stirring assembly.
